(19) United States
(12) Patent Application Publication
(10) Pub. No.: US 2010/0162043 A1
(43) Pub. Date: Jun. 24, 2010

(54) Method, Apparatus, and System for Restarting an Emulated Mainframe IOP

(76) Inventors: Craig F. Russ, Berwyn, PA (US); Matthew A. Curran, Philadelphia, PA (US)

Correspondence Address: UNISYS CORPORATION, UNISYS WAY, MAIL STATION: E8-114, BLUE BELL, PA, 19424, US

(21) Appl. No.: 12/347,196

(22) Filed: Dec. 31, 2008

Related U.S. Application Data
(63) Continuation of application No. 12/340,865, filed on Dec. 22, 2008.

(51) Int. Cl. G06F 11/14

(52) U.S. Cl. 714/17; 714/E11.114

(57) ABSTRACT

A method, apparatus and system for restarting an emulated mainframe IOP, such as a failed or hung emulated mainframe IOP within an emulated mainframe commodity computer. The method includes a rescue process that polls a home location for Restart Request information. In response to receiving Restart Request information, the rescue process is configured to shut down the existing emulated mainframe IOP, start a new emulated mainframe IOP, and reset the home location. The Restart Request information can be provided to the home location by the mainframe computer being emulated. Alternatively, the rescue mechanism can use an interface management card instructed to restart the commodity computer hosting the failed or hung IOP, e.g., from a maintenance service and/or a maintenance program residing in an active commodity computer coupled to the commodity computers hosting one of several emulated mainframe IOPs.

The instant disclosure is a continuation of, and claims the benefit of, U.S. patent application Ser. No. 12/340,865, filed Dec. 22, 2008, which is incorporated herein by reference in its entirety.

### BACKGROUND

1. Field

The instant disclosure relates generally to emulated mainframe computing environments, and more particularly, to emulated mainframe computing environments in which input/output processing is offloaded from a central processing unit (CPU) to an input/output processor (IOP).

2. Description of the Related Art

Computer emulation involves the duplication or emulation of the functions of one computer system, such as a mainframe computer, by another computer system, such as a general purpose or commodity computer. A typical mainframe computer can include at least one central processing unit (CPU) and an input/output processor (IOP), which is provided to offload at least a portion of the input/output processing from the CPU. Mainframe computer emulation can be performed by a suitable commodity computer having appropriate emulation components, such as an emulated mainframe memory component or element, an emulated mainframe CPU, and an emulated mainframe IOP.

The emulated mainframe memory is a memory space within the commodity computer that typically is used to hold the state that normally would be held in the physical memory of the associated mainframe computer. The emulated mainframe CPU is a process that emulates the operations of the mainframe CPU, e.g., obtaining and executing instructions from the emulated mainframe memory and modifying the state of emulated mainframe memory in the same way that a physical mainframe CPU would obtain and execute instructions from mainframe physical memory and modify the state of the mainframe physical memory. The emulated mainframe IOP is a process that emulates the IOP of the associated mainframe computer. For example, the emulated mainframe IOP processes requests issued by the operating system running on the emulated mainframe CPU in the same way that a physical mainframe IOP would process input/output (IO) requests issued by the operating system running on a physical mainframe CPU. Also, the emulated mainframe IOP uses the commodity computer's device drivers and IO hardware to send and receive data to and from environments external to the commodity computer and the mainframe computer.

Conventionally, when an emulated mainframe IOP becomes hung or otherwise fails, the entire mainframe emulation computer (e.g., the commodity computer) must be physically restarted via an appropriate hardware-based restart procedure. Such restart procedure often is relatively time-consuming and usually must be initiated manually. Alternatively, in some non-emulated configurations, a hung or failed IOP can be restarted by its associated mainframe CPU/memory complex, e.g., via an appropriate bus connection therebetween. The operating system of the mainframe computer can then invoke a bus reset to restart and recover a failed or hung mainframe IOP.

### SUMMARY

Disclosed is a method, apparatus and system for restarting and recovering an emulated mainframe IOP, such as a failed or hung emulated mainframe IOP within an emulated mainframe commodity computer, without requiring a restart of the entire commodity computer or the mainframe computer initiating the restart and recover process. The method includes the use of a rescue process, e.g., within the emulated mainframe commodity computer, that polls a home location, e.g., at least partially located in the emulated mainframe memory, for a Restart Request message or other restart information. In response to receiving or otherwise obtaining the restart information, the rescue process is configured to shut down the existing (e.g., failed or hung) emulated mainframe IOP, start a new emulated mainframe IOP, and reset or clear the home location. The Restart Request message or information can be provided to the home location by the mainframe computer that is being emulated by the commodity computer hosting the emulated mainframe IOP. Alternatively, the rescue mechanism can use an interface management card, coupled to or residing within the commodity computer hosting the failed or hung emulated mainframe IOP. The interface management card is configured to restart the commodity computer in response to receiving restart instructions, e.g., from a maintenance service and/or maintenance program residing in or associated with one or more active commodity computers coupled to the commodity computers hosting one of several emulated mainframe IOPs. In some embodiments of the disclosed method, apparatus and system for restarting an emulated mainframe IOP, the commodity computer does not have to be physically restarted to restart a failed emulated mainframe IOP within the commodity computer.

### BRIEF DESCRIPTION OF THE DRAWINGS

FIG. 1 is a schematic view of a conventional commodity computer configured for use in mainframe computer emulation;

FIG. 2 is a schematic view of a commodity computer configured for use in mainframe computer emulation according to an embodiment;

FIG. 3 is a flow diagram of a method for restarting an emulated mainframe IOP according to an embodiment;

FIG. 4 is a schematic view of a conventional mainframe computer;

FIG. 5 is a schematic view of a mainframe computer including a non-emulated CPU/memory complex coupled to a commodity computer configured for use in emulating the mainframe IOP according to an embodiment;

FIG. 6 is a schematic view of an embodiment of an emulated mainframe IOP restart system including a CPU/memory complex coupled to a plurality of commodity computers configured for use in emulating the mainframe IOPs; and

FIG. 7 is a flow diagram of a portion of an alternative method for restarting an emulated mainframe IOP according to an embodiment.

### DETAILED DESCRIPTION

In the following description, like reference numerals indicate like components to enhance the understanding of the disclosed method, apparatus, and system for restarting an emulated mainframe IOP through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

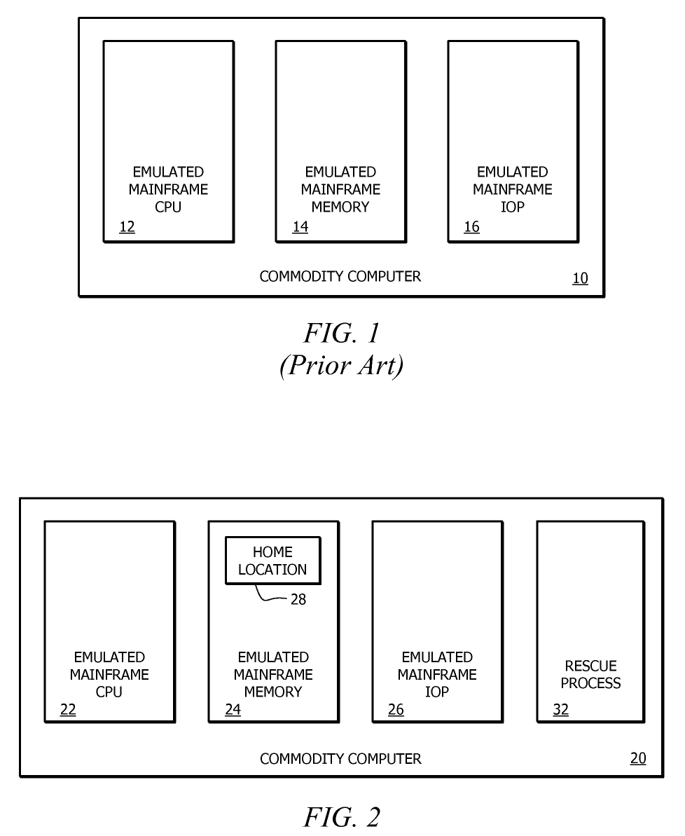

FIG. 1 is a schematic view of an embodiment of a conventional commodity computer 10 configured for use in mainframe computer emulation. The commodity computer 10 includes an emulated mainframe central processing unit (CPU) 12, an emulated mainframe memory element or component 14, and an emulated mainframe input/output processor (IOP) 16. As discussed hereinabove, in a mainframe computer, an IOP is provided to offload at least a portion of the input/output processing from the mainframe CPU.

The emulated mainframe memory 14 is a memory space within the commodity computer 10 that typically is used to hold the state that normally would be held in the physical memory of the corresponding emulated mainframe computer (not shown). The emulated mainframe CPU 12 is a process that emulates the CPU of the corresponding mainframe computer. For example, the emulated mainframe CPU 12 obtains and executes instructions from the emulated mainframe memory 14 and modifies the state of the emulated mainframe memory 14 in the same way that a physical mainframe CPU obtains and executes instructions from a mainframe computer physical memory and modifies the state of the mainframe computer physical memory.

The emulated mainframe IOP 16 is a process that emulates the IOP of the corresponding mainframe computer. For example, the emulated mainframe IOP 16 processes requests issued by the operating system running on the emulated mainframe CPU 12 in the same way that a physical mainframe IOP processes 10 requests issued by the operating system running on a physical mainframe CPU. Also, the emulated mainframe IOP 16 uses the device drivers and input/output (IO) hardware of the commodity computer 10 (not shown) to send data to and receive data from environments external to the emulated mainframe and/or the corresponding commodity computer 10.

The commodity computer 10 also includes messaging and/or queuing mechanisms (not shown) that are used to communicate between the emulated mainframe CPU 12 and the emulated mainframe IOP 16. The commodity computer 10 may also include emulations of mainframe mechanisms (not shown) that configure, start, stop and diagnose various mainframe components. It should be understood that the commodity computer 10 can emulate more than one mainframe CPU and more than one mainframe computer IOP. Also, the components and processes of the commodity computer 10 shown and described herein can be threads and memory objects of a single process rather than separate processes and memory components. Alternatively, within the commodity computer 10, a mixture of components and processes can be used.

As discussed hereinabove, conventionally, if the emulated mainframe IOP 16 fails or becomes hung, the entire commodity computer 10 must be physically restarted via an appropriate hardware-based restart procedure, which typically is relatively time-consuming. Also, such a restart procedure usually must be initiated manually, e.g., by a system administrator.

FIG. 2 illustrates a schematic view of a commodity computer 20 configured for use in mainframe computer emulation according to an embodiment. Like the conventional commodity computer 10 described above, the commodity computer 20 includes an emulated mainframe CPU 22, an emulated mainframe memory element or component 24 and an emulated mainframe IOP 26. Each of the emulated mainframe CPU 22, the emulated mainframe memory 24 and the emulated mainframe IOP 26 are operably coupled to one another. The emulated mainframe memory 24 also includes a home location or memory home location 28, which is a fixed portion or region of the emulated mainframe memory 24.

The commodity computer 20 also includes at least one rescue process 32, which is associated with the emulated mainframe IOP 26, and which periodically polls the home location 28. In some embodiments, the rescue process 32 is configured to restart the emulated mainframe IOP 26, e.g., when the emulated mainframe IOP 26 fails or becomes hung. Although the commodity computer 20 is shown having only one emulated mainframe IOP 26 and one rescue process 32, the commodity computer 20 can include multiple emulated mainframe IOP and rescue process pairs.

Although disclosed herein as processes and/or threads running on the commodity computer, one or more of the emulated mainframe CPU 22, the emulated mainframe memory 24 (including the home location 28), the emulated mainframe IOP 26, and the rescue process 32 can be comprised partially or completely of any suitable structure or arrangement, e.g., one or more integrated circuits. It should also be understood that the commodity computer 20 can include other components including, without limitation, hardware and software (not shown) that are used for the operation of other features and functions of the commodity computer 20 not specifically described herein.

All relevant portions of the commodity computer 20 can be partially or completely configured in the form of hardware circuitry and/or other hardware components within a larger device or group of components. Alternatively, all relevant portions of the commodity computer 20 can be partially or completely configured in the form of software, e.g., as processing instructions and/or one or more sets of logic or computer code. In such configuration, the logic or processing instructions typically are stored in a memory element or a data storage device. The data storage device typically is coupled to a processor or controller, and the controller accesses the necessary instructions from the data storage device and executes the instructions or transfers the instructions to the appropriate location within the respective device.

According to some embodiments, each emulated mainframe IOP 26 within the commodity computer 20 has a corresponding rescue process 32. In such embodiments, the rescue process 32 may periodically poll the home location 28 within the emulated mainframe memory 24, e.g., at 5 second intervals. If the rescue process 32 finds or detects in home location 28 a Restart Request message or instruction for the corresponding emulated mainframe IOP 26, the rescue process 32 may kill or shut down the current process being performed by the emulated mainframe IOP 26. The rescue process 32 can then initiate a new instance of the emulated mainframe IOP process that was just shut down. In some embodiments, the newly initiated mainframe IOP process may be assigned the same IOP number as the shut down emulated mainframe IOP process.

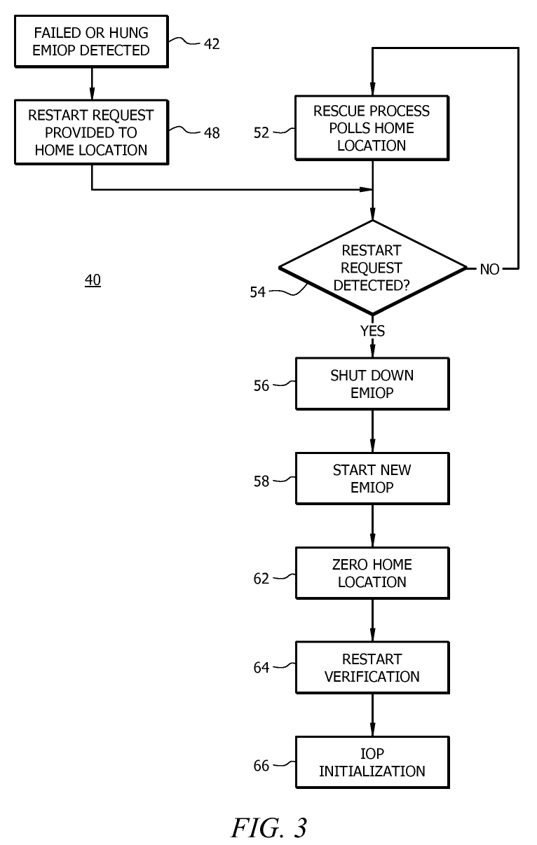

FIG. 3 illustrates a flow diagram 40 of an embodiment of a method for restarting a failed or hung emulated mainframe IOP. In the illustrated embodiment, the method 40 includes a step 42 of determining whether the emulated mainframe IOP has failed or become hung. The detection of a failed or hung emulated mainframe IOP can be performed in any suitable manner. For example, an operating system of a mainframe computer being emulated can detect whether the emulated mainframe IOP has failed or is hung by checking, e.g., at periodic intervals, if each emulated mainframe IOP has completed processing any IO requests during the interval since the previous check. If no IO requests have been completed, a “no operation” I/O request is queued to the emulated mainframe IOP. After that, if no I/O requests have been completed by the next interval check, the emulated mainframe IOP is declared or determined to be failed or hung.

The method 40 can include re-initializing the queuing structures of the failed or hung emulated mainframe IOP. Once a failed or hung emulated mainframe IOP has been detected, the queuing structures of the failed or hung emulated mainframe IOP are re-initialized. The re-initialization can be performed by any suitable component in the commodity computer 20 and/or in the mainframe computer, e.g., in a conventional manner.

The method 40 also can include finding all IO control blocks (IOCBs). Once the queuing structures of the failed or hung emulated mainframe IOP are re-initialized, all IOCBs that had been “in” the failed or hung emulated mainframe IOP, i.e., that were involved in IO processing within the emulated mainframe IOP when the emulated mainframe IOP failed or became hung, are found or identified. For the IOCBs that are located, if the operation of the respective IOCB is the type of operation that can be tried again, the IOCB is placed in an operating system retry queue. However, if the operation of such IOCB is the type of operation that can not be tried again, the IOCB is terminated in error. Finding the IOCBs in the failed or hung emulated mainframe IOP and either placing them in the retry queue or terminating them in error can be performed by any suitable component in the commodity computer 20 and/or in the mainframe computer, e.g., in a conventional manner.

The method 40 also includes a step 48 of providing or placing a Restart Request message or set of instructions in the home location 28. In some embodiments, once a failed or hung emulated mainframe IOP has been detected, a Restart Request message or set of instructions is delivered to the home location 28. For example, an operating system of a mainframe computer coupled to the commodity computer 20 can transmit the appropriate Restart Request message to the home location 28, e.g., within the emulated mainframe memory 24 of the commodity computer 20. In this manner, the Restart Request message or instructions will be available for the rescue process 32 to locate and access.

The method 40 also includes a step 52 of the rescue process 32 polling the home location 28. The rescue process 32 periodically polls the home location 28 at appropriate time intervals, e.g., every 5 seconds. The method 40 includes a step 54 of determining whether a Restart Request message or set of instructions has been detected in the home location 28. During the polling step 52, the rescue process 32 looks for a Restart Request message or set of instructions, or any other suitable information that indicates that an emulated mainframe IOP has failed or has become hung and/or a restart of the emulated mainframe IOP is needed. It should be understood that the rescue process 32 can poll the home location 28 for other appropriate information and instructions, and that other components and/or processes can poll the home location 28 for Restart Request information.

If the determining step 54 does not detect a Restart Request message or set of instructions (N), the rescue process 32 polls the home location 28 again, at the next appropriate time interval. If the determining step 54 detects a Restart Request message, set of instructions or other appropriate emulated mainframe IOP restart information (Y), the rescue process 32 (and/or other appropriate components within the commodity computer 20) will begin the process of restarting the emulated mainframe IOP, e.g., that has failed or become hung.

The method 40 includes a step 56 of shutting down the emulated mainframe IOP that has failed or become hung. The step 56 of shutting down the failed or hung emulated mainframe IOP is performed by the rescue process 32 and/or other appropriate components or processes within the commodity computer 20. The process of shutting down the failed or hung emulated mainframe IOP can be performed in any suitable manner.

The method 40 includes a step 58 of starting a new emulated mainframe IOP. Once the failed or hung emulated mainframe IOP has been shut down (step 56), a new emulated mainframe IOP is started. The step 58 of starting a new emulated mainframe IOP is performed by the rescue process 32 and/or other appropriate components or processes within the commodity computer 20. The process of starting a new emulated mainframe IOP can be performed in any suitable manner.

The method 40 includes a step 62 of resetting or clearing (i.e., zeroing out) the home location 28. Once the failed or hung emulated mainframe IOP has been shut down and a new emulated mainframe IOP started, the home location 28 is reset or cleared. For example, the home location 28 is purged or cleared of any Restart Request messages or other information relating to the previously hung emulated mainframe IOP. The step 62 of clearing the home location 28 is performed by the rescue process 32 and/or other appropriate component or process within the commodity computer 20, and can be performed in any suitable manner.

The method 40 can include a step 64 of verifying that the emulated mainframe IOP has been properly restarted. Once the failed or hung emulated mainframe IOP has been shut down and a new emulated mainframe IOP started, and the home location 28 has been reset or cleared, the step 64 verifies that the emulated mainframe IOP has been restarted properly.

The verification step 64 can be performed in any suitable manner by any appropriate component or components. For example, the operating system of the mainframe computer can poll the home location 28 to determine whether the home location 28 has been cleared or reset, thus indicating that a previously failed or hung emulated mainframe IOP has been shut down and a new emulated mainframe IOP has been properly started. If the operating system of the mainframe computer does not receive a polling response within a certain amount of time, e.g., 10 seconds, a proper restart of the failed emulated mainframe IOP may not be verified, and alternative steps may be taken. For example, an alert may be triggered such than an administrator or other authorized operator can manually restart and re-initialize the (non-verified) emulated mainframe IOP, in a conventional manner.

The method 40 includes a step 66 of initializing (re-initializing) the emulated mainframe IOP. Once the emulated mainframe IOP has been restarted properly and verified as such, the IOP can be re-initialized, e.g., in any suitable manner. For example, the IOP initialization step 66 can include determining whether the emulated mainframe IOP that previously had failed or become hung was redundant, i.e., whether there are other paths available between the devices being served by the previously failed or hung emulated mainframe IOP. If the IOP initialization step 66 determines that the previously failed or hung emulated mainframe IOP is redundant, the IOP initialization step 66 may re-initialize the emulated mainframe IOP by an explicit request, e.g., by an administrator in a conventional manner.

Alternatively, the IOP initialization step 66 can initialize the previously failed or hung emulated mainframe IOP and bring the emulated mainframe IOP back to use in any other suitable manner. For example, the IOP initialization step 66 can involve the same or similar initialization logic as is used for initialization during an initial startup process. Also, as part of the IOP initialization step 66, an Initialize Request message or set of instructions can be placed in the home location 28. In this manner, the Initialize Request message or set of instructions can be accessed by the IOP process 26 or other appropriate components or processes in the commodity computer hosting the emulated mainframe IOP.

It should be understood that the rescue process 32 can service more than one or even all emulated mainframe IOPs in the commodity computer 20. Also, instead of the rescue process 32, a rescue thread can be used in the manner described hereinabove with respect to the rescue process 32. In this manner, the rescue thread may be a thread of the emulated mainframe IOP process, rather than a separate process.

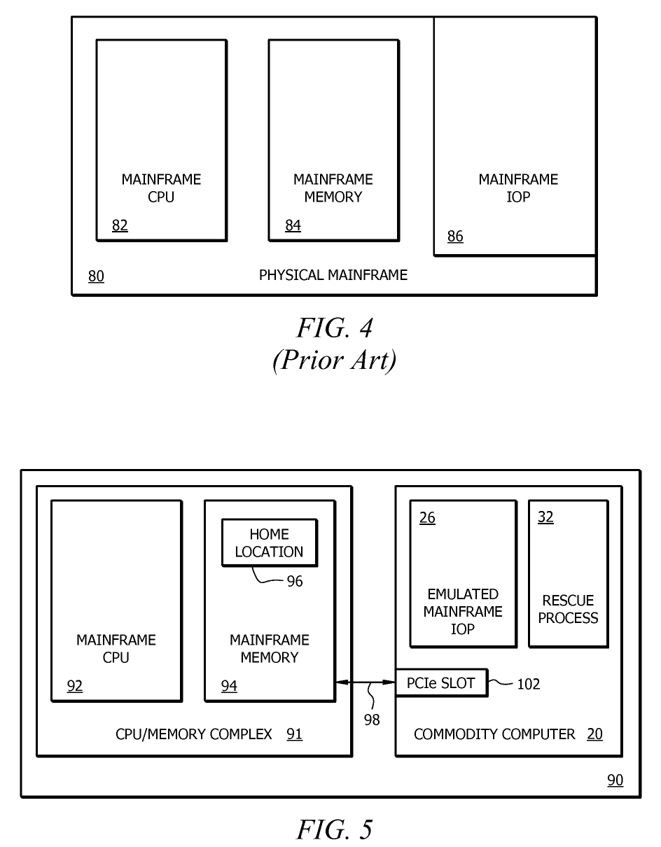

Referring now to FIG. 4, shown is a schematic view of a conventional mainframe computer system 80, which is a physical computer system built to execute a particular instruction set. The mainframe computer system 80 includes a CPU/memory complex including at least one mainframe CPU 82 and a mainframe memory element or component 84. The mainframe computer system 80 also includes at least one mainframe IOP 86 coupled to the mainframe CPU 82. The mainframe memory 84 is a real or physical memory element or component. For example, the mainframe memory 84 can be a set of dual in-line memory modules (DIMMs) connected to the mainframe CPU 82 and the mainframe IOP(s) 86 via either a commodity memory interconnect or a custom application specific integrated circuit (ASIC). The mainframe CPU 82 is a hardware entity that retrieves and executes instructions from the mainframe memory 84 and modifies the state of the mainframe memory 84. For example, the mainframe CPU 82 can be a custom ASIC.

As discussed hereinabove, the mainframe IOP 86 is provided to offload at least a portion of the input/output processing from the mainframe CPU 82. The mainframe IOP 86 is a hardware entity that processes IO requests issued by the operating system running on the mainframe CPU 82. For example, the mainframe IOP 86 can be a peripheral component interconnect (PCI) card, a PCI-X card or a PCIe card containing a custom ASIC, some physical memory, external interface hardware (e.g., fiber channel and Ethernet), and a commodity processor chip running the IOP firmware of the mainframe IOP 86.

It should be understood that the mainframe computer system 80 usually includes multiple CPUs and multiple IOPs. Also, it should be understood that the mainframe computer system 80 includes messaging and/or queuing mechanisms (not shown) that are used to communicate between the mainframe CPU 82 and the mainframe IOP 86. Also, it should be understood that the mainframe computer system 80 includes mechanisms that configure, start, stop, and diagnose various mainframe computer components, including those components not shown or described herein.

When the mainframe IOP 86 fails or hangs, the operating system running on the mainframe CPU 82 invokes an appropriate command on a PCI bus (not shown) coupled between the mainframe CPU 82 and the mainframe IOP 86 to reset and recover the mainframe IOP 86. For example, the mainframe IOP 86 typically is or includes a PCI card and the mainframe CPU/memory complex typically is a PCI host (a PCI host typically can reset a PCI card).

While such traditional techniques are adequate for restarting IOPs implemented in conventional computing systems, the instant disclosure is directed to systems and methods which facilitate the virtualization of IOPs, thereby removing their dependence on hardware-specific functionality. By way of example, in some embodiments, the mainframe IOP may be emulated on a commodity computer with PCI slots, i.e., the commodity computer hosting the IOP emulation can be a PCI host. In such embodiments, the CPU/memory complex can play the role of a PCI card from the point of view of the commodity computer hosting the IOP emulation. Therefore, there will be no physical mechanism in the hardware platform that the operating system running on the mainframe CPU 82 may invoke to restart and recover a failed or hung mainframe IOP 86.

FIG. 5 illustrates a schematic view of an embodiment of a modified mainframe computer 90 including a commodity computer 20 configured for use in emulating the mainframe IOP. In the illustrated embodiment, the mainframe computer includes a CPU/memory complex 91 that includes a mainframe CPU 92 and a mainframe memory element or component 94. The mainframe CPU 92 and the mainframe memory 94 within the CPU/memory complex 91 are similar to the mainframe CPU 82 and the mainframe memory 84 within the conventional mainframe computer system 80, described hereinabove with respect to FIG. 4. However, as FIG. 5 illustrates, the mainframe memory 94 is modified to include the home location (shown as home location 96) that resided solely within the emulated mainframe memory portion 24 of the commodity computer 20 (shown in FIG. 2).

The commodity computer 20 is similar to the commodity computer described hereinabove and illustrated in FIG. 2. However, the emulated mainframe IOP 26 can use a different mechanism to read from and write to the home location 96, which resides in the mainframe memory 94. For example, the commodity computer 20 includes an interface bus 98, such as a PCIe bus, for coupling the commodity computer 20 to the mainframe CPU/memory complex 91. For example, a PCIe interface bus coupled between the CPU/memory complex 91 and the commodity computer 20 terminates to a PCIe card (not shown), which is positioned in a PCIe slot 102 in the commodity computer 20. The interface bus 98 has any suitable hardware topology, e.g., eight PCIe lanes. In one embodiment, the CPU/memory complex has four instances of the interface bus 98. The four interface buses allow up to four commodity computers to be used, with each commodity computer hosting one or more emulated mainframe IOPs. Alternatively, the four interface buses can be used to connect two commodity computers, each with a redundant path to the CPU/memory complex 91. It should be noted that the interface busses carry all data transferred between mainframe memory and IOP(s), including IO control block data and file data, in addition to home location data.

When the emulated mainframe IOP 26 fails or becomes hung, the detection and restart method 40 described hereinabove is used. However, such method 40 usually works when only the emulated mainframe IOP 26 has failed or become hung. When the operating system of the commodity computer 20 also fails, or when the IO hardware (not shown) in the commodity computer 20 also fails or hangs in such a way that the operating system of the commodity computer 20 cannot recover the use of the IO hardware, the restart method 40 discussed previously herein may not be sufficient. Accordingly, the commodity computer 20 sometimes must be restarted to recover use of the emulated mainframe IOP 26. Such restart could be initiated manually be a person. In some embodiments, an alternative detection and restart method is described hereinbelow that restarts the commodity computer without requiring manual intervention.

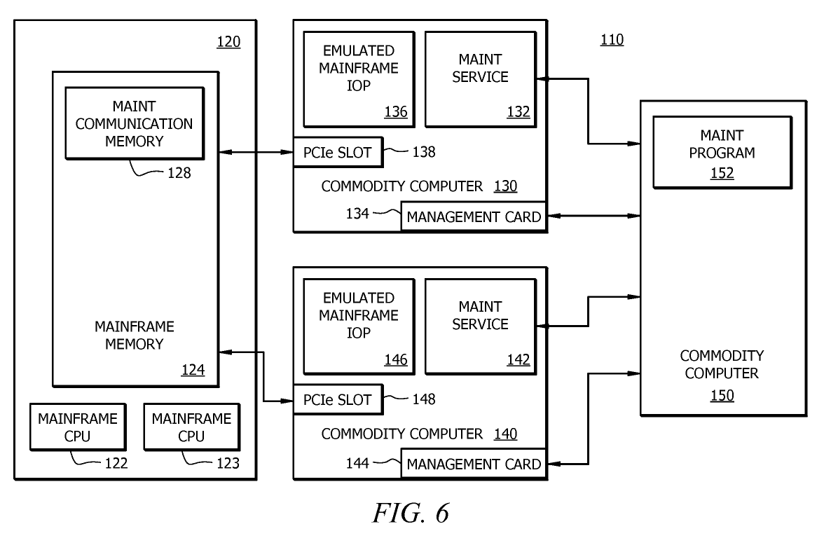

FIG. 6 illustrates a schematic view of an embodiment of an emulated mainframe IOP restart system 110 including a mainframe computer CPU/memory complex 120 coupled to at least two commodity computers, e.g., a first commodity computer 130 and a second commodity computer 140, each configured for use in emulating mainframe IOPs. The system 110 has a maintenance infrastructure (a portion of which is shown), which is conventional in many mainframe computers. In general, the maintenance infrastructure is configured to start, stop, monitor and diagnose components of the mainframe CPU/memory complex 120. The system 110 also includes at least one commodity computer 150 having a maintenance program 152, as will be discussed in greater detail hereinbelow.

The mainframe CPU/memory complex 120 includes at least one mainframe CPU, e.g., a first mainframe CPU 122 and a second mainframe CPU 123. It should be understood that the mainframe computer CPU/memory complex 120 can have more than two CPUs. The mainframe computer CPU/memory complex 120 also includes a mainframe memory element or component 124. The mainframe memory 124 within the mainframe computer CPU/memory complex 120 includes a maintenance communication memory element 128, which is a fixed region within the mainframe memory 124. A portion of the maintenance communication memory element 128 is reserved for messages from the operating system of the mainframe computer to the maintenance program 152. Another portion of the maintenance communication memory element 128 is reserved for messages from the maintenance program 152 to the operating system of the mainframe computer.

The system 110 also includes a maintenance program 152, which runs on a commodity computer 150 separate from the components of the mainframe computer CPU/memory complex 120. It should be understood that multiple maintenance programs can be running on multiple commodity computers, e.g., for purposes or redundancy. In the illustrated embodiment, commodity computer 150 is coupled to each of the commodity computers 130, 140, e.g., in an appropriate manner, as will be discussed hereinbelow. The maintenance program 152 is configured to monitor the mainframe computer CPU/memory complex 120, as well as start, stop and/or diagnose the mainframe computer CPU/memory complex 120 in response to operator input. The operator providing the input typically is a person using the maintenance program 152 via its graphic user interface (not shown), although a programmatic interface to the maintenance program 152 is possible.

In the illustrated embodiment, the first commodity computer 130 includes a maintenance service element or component 132, an interface management card 134 and an emulated mainframe IOP 136, as well as other elements and components that are not shown. The first commodity computer 130 also includes a PCIe slot 138 or other appropriate termination element for coupling an appropriate interface bus between the first commodity computer 130 and the mainframe memory 124 of the mainframe computer CPU/memory complex 120. In this embodiment, the maintenance service 132 is a service (daemon) that processes requests from the maintenance program 152 and sends corresponding responses to the maintenance program 152. The maintenance service 132 also monitors the components of the mainframe computer CPU/memory complex 120 and sends messages to the maintenance program 152 when events occur that are relevant to the components of the mainframe computer CPU/memory complex 120.

In the embodiment illustrated in FIG. 6, the second commodity computer 140 includes a maintenance service element or component 142, an interface management card 144 and an emulated mainframe IOP 146, among other elements and components that are not shown. The second commodity computer 140 also includes a PCIe slot 148 or other appropriate termination element for coupling an appropriate interface bus between the second commodity computer 140 and the mainframe memory 124 of the mainframe computer CPU/memory complex 120. In this embodiment, the maintenance service 142 is a service (daemon) that processes requests from the maintenance program 152 and sends corresponding responses to the maintenance program 152. The maintenance service 142 also monitors the components of the mainframe computer CPU/memory complex 120 and sends messages to the maintenance program 152 when events occur that are relevant to the components of the mainframe computer CPU/memory complex 120.

As discussed previously herein, part of the maintenance communication memory 128 within the mainframe computer CPU/memory complex 120 is reserved for messages from the operating system of the mainframe to the maintenance program 152. Each of the maintenance service 132 and the maintenance service 142 periodically polls the maintenance communication memory 128 and forwards any message(s) found therein to the maintenance program 152. Also, as discussed hereinabove, part of the maintenance communication memory 128 may also be reserved for messages from the maintenance program 152 to the operating system of the mainframe. Such messages are placed in the maintenance communication memory 128 by one or more of the maintenance service 132 and the maintenance service 142.

According to some embodiments, commodity computers hosting emulated mainframe IOPs, e.g., the first commodity computer 130 and the second commodity computer 140, each have an interface management card that includes out-of-band management capabilities. In general, interface management cards (or management cards) are relatively small secondary computers that often can be found installed in many commercially available servers. A management card is configured to run independently of its server, and a management card typically has access to hardware features of the server that allow the management card to perform various functions, e.g., restart the associated server and power cycle the associated server. Typically, a management card performs one or more of these functions in response to requests received over its interface, e.g., a TCP/IP interface. However, such requests usually must be accompanied by appropriate credentials, e.g., a valid password. As discussed, in the illustrated embodiment, each of the commodity computers hosting emulated mainframe IOPs includes an interface management card.

For the system 110, as discussed hereinabove, when an emulated mainframe IOP fails or becomes hung, the detection and restart method 40 previously described hereinabove can be used to restart the failed emulated mainframe IOP. However, when the operating system of the commodity computer hosting the failed or hung emulated mainframe IOP also fails or becomes hung in a manner that prohibits the operating system of the commodity computer from recovering the use of the IO hardware, additional steps may be required to properly restart the emulated mainframe IOP and the commodity computer hosting the emulated mainframe IOP.

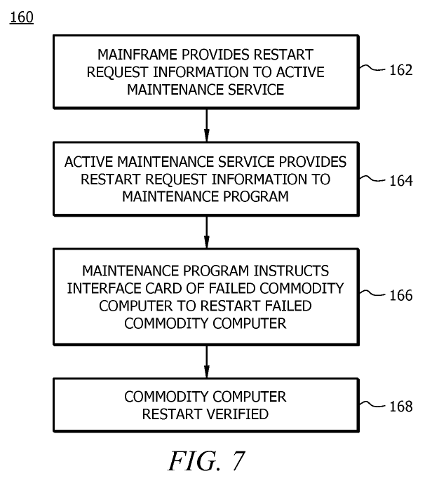

FIG. 7 illustrates a block diagram of an alternative method 160 for restarting an emulated mainframe IOP. Such an alternative method 160 can be used as part of the method 40 shown in FIG. 3, e.g., as part of or in addition to the restart verification step 64. However, it should be understood that the alternative method 160 also can be performed independent of the method 40.

For example, as discussed hereinabove, the operating system of the mainframe computer can poll the home location 28 to determine whether the home location 28 has been reset or cleared (zeroed out), thus indicating that a previously failed or hung emulated mainframe IOP has been shut down and a new emulated mainframe IOP has been properly started. If the operating system of the mainframe computer does not receive a polling response within a certain period of time, e.g., 10 seconds, a proper restart of the failed emulated mainframe IOP may not be verified. In such case, the method 160 can be used to restart the failed or hung emulated mainframe IOP, and, if needed, the operating system of the commodity computer hosting the failed or hung emulated mainframe IOP.

The method 160 includes a step 162 of the mainframe computer CPU/memory complex 120 providing Restart Request information to the maintenance service of at least one active (i.e., non-failed or non-hung) commodity computer hosting an emulated mainframe IOP. For example, the mainframe computer CPU/memory complex 120 provides an appropriate Restart Request message to the maintenance program portion (not shown) of the maintenance communication memory 128. For example, the Restart Request message requests that the commodity computer hosting the non-responsive emulated mainframe IOP be restarted.

The method 160 also includes a step 164 of the maintenance service of an active commodity computer providing the Restart Request information to the maintenance program 152 in the commodity computer 150. A maintenance service running on an active commodity computer, i.e., a commodity computer that has not failed, can find the Restart Request message in the maintenance communication memory 128 of the mainframe computer CPU/memory complex 120. The maintenance service finding the Restart Request message forwards the Restart Request message to the maintenance program 152 of the commodity computer 150, via an appropriate interface therebetween.

The method 160 also includes a step 166 of the maintenance program 152 of the commodity computer 150 instructing the interface management card of the failed commodity computer to restart the failed commodity computer. Once the maintenance program 152 of the commodity computer 150 receives appropriate Restart Request information from the maintenance service of an active commodity computer, the maintenance program 152 of the commodity computer 150 can, in turn, instruct the interface management card of the failed commodity computer to restart the failed commodity computer. The maintenance program 152 requests that the appropriate interface management card reboot, or power cycle, its associated server, whichever is appropriate.

The method 160 also includes a step 168 of verifying that the failed commodity computer has been restarted. Once the maintenance program 152 of the commodity computer 150 has instructed the interface card of the failed commodity computer to restart the failed commodity computer, the operating system of the mainframe computer waits for the restarted commodity computer to come online. For example, the maintenance program 152 can use the interface management card of the restarted commodity computer to poll the status of the restarted commodity computer. The maintenance program 152 can send a message to the operating system of the mainframe computer when the commodity computer has been successfully restarted. Alternatively, the operating system of the mainframe computer periodically can try IOP initialization of the previously hung IOP. Once the verification step 168 has verified that the restarted commodity computer has come online, the commodity computer's emulated mainframe IOP can be re-initialized, e.g., by the IOP initialization step 66 in the method 40.

The method illustrated shown in FIG. 3 may be implemented in a general, multi-purpose or single purpose processor. Such a processor will execute instructions, either at the assembly, compiled or machine-level, to perform that process. Those instructions can be written by one of ordinary skill in the art following the description of FIG. 3 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, and silicon memory (e.g., removable, non-removable, volatile or non-volatile).

It will be apparent to those skilled in the art that many changes and substitutions can be made to the embodiments described herein without departing from the spirit and scope of the invention as defined by the appended claims and their full scope of equivalents.

1. A method for restarting a thread within a commodity computer, the method comprising:
polling a memory home location for a Restart Request message; and
initiating a rescue mechanism in response to detecting a Restart Request message in the memory home location,
the rescue mechanism comprising,
shutting down the thread within the commodity computer,
starting a new thread within the commodity computer, and
resetting the contents of the memory home location.

2. The method as recited in claim 1, wherein the Restart Request message is provided to the memory home location by an operating system of a mainframe computer that is being emulated by the commodity computer.

3. The method as recited in claim 2, wherein the mainframe computer operating system provides the Restart Request message to the memory home location in response to the mainframe computer operating system detecting that at least one thread within the commodity computer has failed.

4. The method as recited in claim 1, wherein the Restart Request message is retrieved from the memory home location by a service running on the commodity computer, and forwarded to a maintenance program residing in at least one active commodity computer coupled to the commodity computer.

5. The method as recited in claim 1, wherein the commodity computer includes an interface management card, and wherein at least a portion of the rescue mechanism is performed in response to the interface management card receiving restart instructions.

6. The method as recited in claim 5, wherein the interface management card receives restart instructions from at least one of a maintenance service and a maintenance program residing on at least one active commodity computer coupled to the interface management card.

7. The method as recited in claim 1, wherein the method further comprises a step of verifying that the new thread has been started.

8. The method as recited in claim 1, wherein the memory home location resides at least partially within the commodity computer.

9. The method as recited in claim 1, wherein the memory home location resides at least partially within the memory of a mainframe CPU/memory complex whose processes are emulated and being hosted on the commodity computer.

10. The method as recited in claim 1, wherein the method further comprises a step of initializing the new thread that has been started.

11. The method as recited in claim 1, wherein the rescue mechanism further comprises a rescue thread.

12. The method as recited in claim 11, wherein the rescue thread further comprises a thread of an emulated mainframe input/output processor (IOP) process hosted by the commodity computer.

13. An apparatus for emulating a mainframe computer having a mainframe CPU/memory complex, the apparatus comprising:
an emulated mainframe memory component including at least a portion of a home location; and
a rescue mechanism coupled to the emulated mainframe memory component, wherein the rescue mechanism is configured to
poll the home location for a Restart Request message, and
initiate, in response to detecting a Restart Request message, a procedure for restarting at least one thread within a commodity computer hosting or coupled to the apparatus, wherein the restarting procedure includes
shutting down the thread within the commodity computer,
starting a new thread within the commodity computer, and
resetting the contents of the home location.

14. The apparatus as recited in claim 13, wherein the apparatus includes an operating system, and wherein the apparatus further comprises an interface management card, wherein the interface management card is configured to restart the at least one thread and to restart the operating system of the apparatus.

15. The apparatus as recited in claim 14, wherein the interface management card is configured to restart the at least one thread and the operating system of the apparatus in response to receiving Restart Request information from a maintenance program residing on the commodity computer.

16. The apparatus as recited in claim 13, further comprising a maintenance service configured to retrieve Restart Request information from the mainframe CPU/memory complex and to forward Restart Request information to a maintenance program residing on the commodity computer.

17. The apparatus as recited in claim 13, wherein the Restart Request message is provided to the home location by an operating system of the mainframe computer, and wherein the mainframe computer operating system provides the Restart Request message to the home location in response to the mainframe computer operating system detecting that the at least one thread has failed.

18. The apparatus as recited in claim 13, wherein the rescue mechanism further comprises a rescue thread.

19. The apparatus as recited in claim 18, wherein the rescue thread further comprises a thread of an emulated mainframe input/output processor (IOP) process hosted by the commodity computer.

20. The apparatus as recited in claim 13, wherein the rescue mechanism further comprises a thread.

21. A computer readable medium having instructions stored thereon which, when executed by a processor, carry out a method for restarting a thread within a commodity computer, the instructions comprising:
instructions for polling a memory home location for a Restart Request message; and
instructions for initiating a rescue mechanism in response to detecting a Restart Request message in the memory home location,
the rescue mechanism instructions comprising,
instructions for shutting down the thread within the commodity computer,
instructions for starting a new thread within the commodity computer, and
instructions for resetting the contents of the memory home location.
